(19) United States
(12) Patent Application Publication
(10) Pub. No.: US 2003/0182393 A1
(43) Pub. Date: Sep. 25, 2003

(54) System and method for retrieving uniform resource locators from television content

(75) Inventors: Christopher M. Tobin, McLean, VA (US); Greg Gudorf, San Diego, CA (US); Aaron Dew, San Diego, CA (US); Anthony Creed, San Diego, CA (US); Matthew Chang, San Diego, CA (US); Rolf Toft, San Francisco, CA (US)

Correspondence Address: Rogitz & Associates, Suite 3120, 750 B Street, San Diego, CA, 92101, US

(73) Assignees: SONY CORPORATION, Tokyo (JP); SONY ELECTRONICS INC., Park Ridge, NJ

(21) Appl. No.: 10/106,835

(22) Filed: Mar. 25, 2002

(51) Int. Cl. G06F 15/16

(52) U.S. Cl. 709/217

(57) ABSTRACT

A system and method for retrieving uniform resource locators from television content includes a television that receives a broadcast signal. The broadcast signal includes embedded URL information. Moreover, the television includes a remote control unit that has a memory slot that is sized and shaped to receive a portable memory media. In response to a signal received at the television, e.g., from the remote control unit, the embedded URL is extracted from the broadcast signal and downloaded to the remote control unit. To facilitate Internet use, the downloaded URL can be transmitted to an Internet device, e.g., a computer or a personal digital assistant where it can be used to access information associated with Web sites linked to the URLs.

### 1. FIELD OF THE INVENTION

The present invention relates generally to television systems.

### 2. DESCRIPTION OF THE RELATED ART

Televisions and computers have become ubiquitous. Oftentimes television programs and television commercials include uniform resource locators (URLs) that, when entered into devices having Internet access, link the viewer to websites to provide further information about products, services, television programs, upcoming movies, etc. Typically, the URLs, also referred to as “links,” are provided to the viewer via spoken word or text displayed on the television screen.

Unfortunately, while watching television viewers are presently unable to simply download lists of URLs that are broadcast. Viewers, if interested in particular URLs, must write them down or remember them for later use. Or, viewers who have computers or other Internet devices must manually enter URLs of interest into their computers as they are broadcast and surf the Internet while watching television.

Accordingly, it is an object of the present invention to provide a means by which URLs easily can be retrieved from television signals and transmitted to an Internet device.

### SUMMARY OF THE INVENTION

A method for transferring computer hyperlink information from a television to a computer includes receiving the hyperlink information at a remote control device and storing the information therein. Then, the hyperlink information is uploaded from the remote control device to the computer.

In a preferred embodiment, the remote control unit includes a portable memory media to which the hyperlink information is downloaded. Moreover, the remote control unit includes a “links” button. When the television receives a signal in response to the “links” button being depressed, the hyperlink information is transmitted from the television to the remote control device. Preferably, the portable memory media is a flash memory device.

In another aspect of the present invention, a method for facilitating Internet use includes embedding at least one uniform resource locator (URL) in a broadcast signal that is receivable by a TV. In response to a user command, the URL is transferred from the TV to a user input device. The URL is stored at the user input device and then, transmitted from the user input device to an Internet device.

In yet another aspect of the present invention, a system for promoting Internet use includes a television that receives a signal that has at least one URL therein. In this aspect, the system includes a user input device to cause the URL to be stored therein. Also, the system includes an Internet device that is distanced from the user input device. The Internet device receives the URL from the user input device.

In still another aspect of the present invention, a television includes means for receiving a broadcast signal that has one or more URLs embedded therein. Further, the television includes means for receiving at least one user command from a user input means and means for transferring the URL from the TV to the user input means, in response to the user command.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention; and

FIG. 2 is flow chart showing the method of the present invention.

### DETAILED DESCRIPTION OF THE PREFERRED EMBODIMENTS

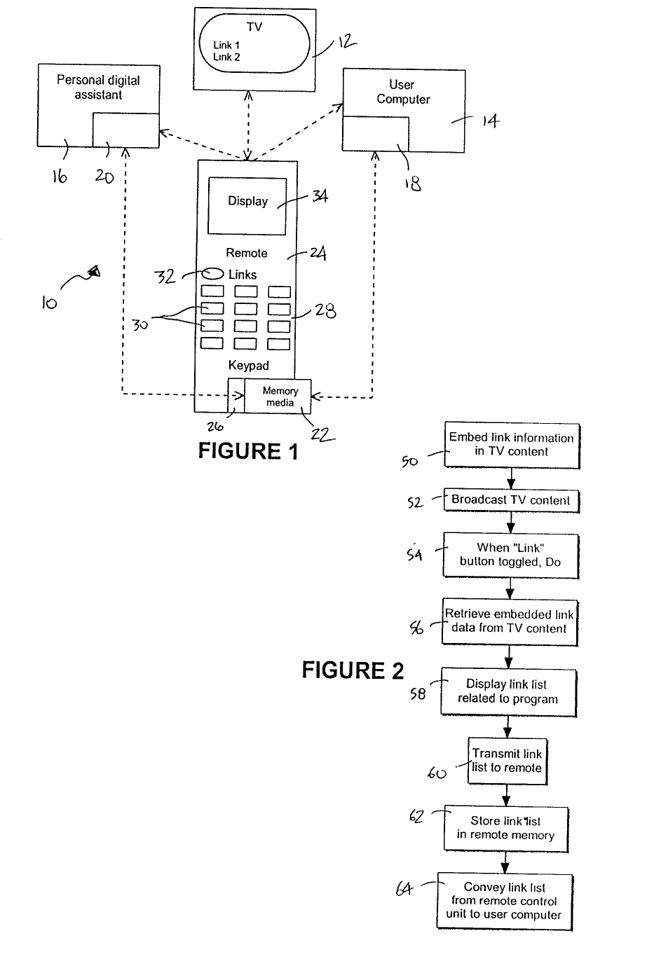

Referring initially to FIG. 1, a system is shown, generally designated 10. As shown, the system 10 includes a television TV 12, a computer 14, and a personal digital assistant (PDA) 16. FIG. 1 shows that the computer 14 and the PDA 16 each include respective memory slots 18, 20 that are sized and shaped to receive a correspondingly sized and shaped portable memory media 22.

In a preferred embodiment, the portable memory media 22 is a flash memory device, e.g., a Memory Stick® manufactured and sold by Sony®. However, it is to be appreciated that the portable memory media 22 can be a portable random access memory (RAM) device, a portable electrically erasable programmable read-only memory (EEPROM) device, or any other similar portable media useful for transferring data or information from one device to another.

Moreover, it is to be understood that the TV 12 receives broadcast content having hyperlink data including, but not limited to URL information embedded therein. Preferably, the URLs, or links, are embedded in the broadcast signals much like embedded closed captioning information. Or, the information can be embedded in the vertical blanking interval (VBI) of the television signal. Each URL can include a designator, e.g., “linkinfo,” to indicate that it is to be captured for downloading as described below. The URLs can be displayed at the TV 12 as they are received or they can remain embedded so that they are not displayed at the TV 12. Alternatively, images that are broadcast to the TV 12 can be scanned for text displayed therein and any text including, e.g., “www”, would be captured and downloaded as described below. It can be appreciated that the URLs can include links to websites that provide supplemental information concerning particular television shows, news broadcasts, products, services, upcoming movies, upcoming events, etc.

As further shown in FIG. 1, the system 10 includes a remote control unit 24. Preferably, the remote control unit 24 includes a memory slot 26 that is also sized and shaped to receive the portable memory media 22. Moreover, the remote 24 includes a keypad 28 having plural control buttons 30 thereon. In a preferred embodiment, the key pad 28 also includes a “links” button 32. As described in detail below, when the “links” button 32 is toggled, a list of links embedded in the TV content are transmitted to the remote control unit 24 and stored in the portable memory media 22.

Further, the remote control unit 24 can include a display 34 that allows a user to view the links on the remote control unit 24. It is to be appreciated that the remote control unit 24 can include a wireless Internet connection and as such, can be used to “surf” the Internet based on the links transmitted thereto by the TV 12 when the “links” button 32 is toggled.

It is to be understood that in a preferred embodiment the remote control unit 12 transmits infrared (IR) signals that can be received by the TV 12, the user computer 14, and/or the PDA 16. However, the remote control unit 12 can also transmit radio frequency (RF) signals. Moreover, the memory media 22 can be installed in the remote control unit 24, the user computer 14, and/or the PDA 16. It is also to be understood that the TV 12 transmits the URL information to the remote control unit 24 via IR signals or RF signals that are received by the remote control unit 24.

Now referring to FIG. 2, the method steps of the present invention can be seen. Commencing at block 50, the link data described above is embedded in television content received at the TV 12. Thereafter, at block 52, the TV content with the embedded link information is broadcast so that it can be received at the TV 12. At block 54, a do loop is entered wherein when the “links” button is toggled or otherwise depressed and a “links” signal is received at the TV 12, the following steps are performed.

At block 56, the embedded link information is retrieved from the TV content. Proceeding to block 58, a list of links relating to a particular program, news broadcast, commercial, etc. are displayed at the TV 12. Next, at block 60, the list of links is transmitted to the remote control unit 24. It is to be understood that the list can be viewed at the remote control unit 24 via the display 34 incorporated into the remote control unit 24. Continuing to block 62, the list of links is stored in the memory media 22 installed in the remote control unit 24. Then, at block 64, the list of links is conveyed from the remote control unit to the user computer 12 or PDA 16. The list can be conveyed by physically disengaging the portable memory media 22 from the remote control unit 24 and engaging it with the user computer 14 or PDA 16. Conversely, the list of links can be transmitted wirelessly from the remote control unit 24 to the user computer 14 or the PDA 16. Or, the TV 12 can be directly connected to the user computer 14 by, e.g., a wire, device so that the TV 12 transmits the link information the computer 14 or PDA 16 via the wire.

With the above describe system and method, a user is able to download URLs or links that are broadcast at the TV 12. The same user is then able to convey the downloaded URLs to his or her computer so that he can obtain information from websites linked to the URLs.

While the particular SYSTEM AND METHOD FOR RETRIEVING UNIFORM RESOURCE LOCATORS FROM TELEVISION CONTENT as herein shown and described in detail is fully capable of attaining the above-described aspects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

We claim:

1. A method for transferring computer hyperlink information from a television to a computer, comprising:
receiving the hyperlink information at a remote control device and storing the information therein; and
uploading the hyperlink information from the remote control device to the computer.

2. The method of claim 1, wherein the remote control unit includes a portable memory media to which the hyperlink information is downloaded.

3. The method of claim 1, wherein the remote control unit includes a “links” 10 button and the method further includes the acts of:
in response to a signal received at the television when the “links” button is depressed, transmitting the hyperlink information from the television to the remote control device.

4. The method of claim 2, wherein the portable memory media is a flash memory device.

5. A method for facilitating Internet use, comprising:
embedding at least one uniform resource locator (URL) in a broadcast signal receivable by a TV;
in response to a user command, transferring the URL from the TV to a user Input device;
storing the URL at the user input device; and transmitting the URL from the user input device to an Internet device.

6. The method of claim 5, wherein the user command is generated using the user input device.

7. The method of claim 5, wherein the Internet device is one of: a computer and a personal data assistant.

8. The method of claim 5, wherein the user input device includes a portable memory media and the URL is stored therein.

9. The method of claim 8, further comprising the acts of:
disengaging the portable memory media from the user input device; engaging the portable memory media with the Internet device; and uploading the URL from the portable memory media to the Internet device.

10. The method of claim 8, wherein the portable memory media is a flash memory device.

11. The method of claim 6, wherein the user input device is a remote control unit.

12. The method of claim 11, wherein the remote control unit includes a “links” button, the user command being generated when the “links” button is depressed.

13. A system for promoting Internet use, comprising:
at least one TV receiving a signal having at least one URL therein;
at least one user input device to cause the URL to be stored therein; and
at least one Internet device distanced from the user input device to receive the URL from the user input device.

14. The system of claim 13, wherein the user input device is a remote control unit.

15. The system of claim 14, wherein the remote control unit includes a “links” button, the “links” button being depressed to cause the URL to be stored in the remote control unit.

16. The system of claim 14, wherein the remote control unit includes a portable memory media on which the URL is stored.

17. The system of claim 16, wherein the portable memory media is a flash memory device.

18. A television, comprising:
means for receiving a broadcast signal having at least one URL embedded therein;
means for receiving at least one user command from a user input means; and
means for transferring the URL from the TV to the user input means, in response to the user command.

19. The television of claim 18, wherein the user input means includes a portable memory means on which the URL is stored, the portable memory means being used to transfer the URL from the user input means to an Internet device.
